(19) United States
(12) Patent Application Publication
(10) Pub. No.: US 2008/0195617 A1
(43) Pub. Date: Aug. 14, 2008

(54) Modified machine architecture with machine redundancy

(76) Inventor: John M. Holt, Essex (GB)

Correspondence Address: PERKINS COIE LLP, P.O. BOX 2168, MENLO PARK, CA, 94026, US

(21) Appl. No.: 12/011,215

(22) Filed: Jan. 23, 2008

Related U.S. Application Data
(62) Division of application No. 11/583,962, filed on Oct. 18, 2006.
(60) Provisional application No. 60/730,303, filed on Oct. 25, 2005.

(51) Int. Cl. G06F 17/30

(52) U.S. Cl. 707/8; 707/E17.005

(57) ABSTRACT

A multiple computer system in which a single application program, written to execute on only a single computer, runs on multiple computers is disclosed. Each computer (M1, . . . Mn) has a substantially identical local memory structure. Synchronizing locks are used to ensure that only one computer is able to write to a local memory location and all other computers are prohibited to writing to their corresponding memory location. In the event of failure of a computer holding such a lock, the lock is arranged to be released. The released lock can then be re-allocated to another computer which has not failed. In this way failure of one, or a sequence of, computers, does not result in failure of the whole computer system.

### CROSS-REFERENCE TO RELATED APPLICATIONS

This is a divisional of U.S. application Ser. No. 11/583,962 filed Oct. 18, 2006 entitled “Modified Machine Architecture With Machine Redundancy,” and claims benefit of priority to U.S. Provisional Application No. 60/730,303 entitled “Modified Machine Architecture with Machine Redundancy” filed 25 Oct. 2005; which is hereby incorporated by reference.

### FIELD OF THE INVENTION

The present invention relates to computing and, in particular, to the simultaneous operation of a plurality of computers interconnected via a communications network.

### BACKGROUND ART

International Patent Application No. PCT/AU2005/000580 (Attorney Ref 5027F-WO) published under WO 2005/103926 (to which U.S. patent application Ser. No. 11/111,946 and published under No. 2005-0262313 corresponds) in the name of the present applicant, discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (Attorney Ref: 5027F-D2-WO) in the name of the present applicant and unpublished as at the priority date of the present application, also disclose further details. The contents of each of the abovementioned prior application(s) are hereby incorporated into the present application by cross reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

In many situations, the above-mentioned arrangements work satisfactorily. This applies particularly where the programmer is aware that there may be updating delays and so can adjust the flow of the program to account for this. However, there are situations in which the use of stale contents or values instead of the latest content can create problems.

The genesis of the present invention is to provide a redundant system in which, in the event of failure of a single machine, the other machines do not themselves cease operation but instead are still able to function (at least to some extent) thereby avoiding total failure of the entire system.

### SUMMARY OF THE INVENTION

In accordance with a first aspect of the present invention there is disclosed in a multiple computer environment in which an application program written to execute only on a single computer runs simultaneously on a plurality of computers each of which has a local memory in which globally named objects, assets or resources are locally substantially replicated and in which a synchronizing lock corresponding to the global name is acquired and released in sequence by any computer utilizing one of said objects, assets or resources, said lock authorizing the acquiring computer to update the local contents of the locked object, asset or resource and preventing all other computers accessing their corresponding local object, asset or resource, the improvement comprising the step of: following computer failure of any computer which has acquired but not released any specific lock,

(i) releasing said specific lock, whereby said application program running conducted by the non-failed ones of said computers can continue by allocation of said lock to a non-failed one of said computers in due course, if necessary.

In accordance with a second aspect of the present invention there is disclosed a multiple computer system in which an application program written to execute only on a single computer runs simultaneously on said multiple computers each of which has a local memory in which globally named objects, assets or resources are locally substantially replicated and in which a synchronizing lock corresponding to the global name is acquired and released in sequence by any computer utilizing one of said objects, assets or resources, said lock authorizing the acquiring computer to update the local contents of the locked object, asset or resource and preventing all other computers accessing their corresponding local object, asset or resource, wherein said system includes a computer failure detector to detect failure of any one of said computers and release means to release any lock acquired but not released by a failed computer, whereby said application program running conducted by the non-failed ones of said computers can continue allocation of said lock to a non-failed one of said computers in due course, if necessary.

In accordance with a third aspect of the present invention there is disclosed a single computer intended to operate in a multiple computer system which comprises a plurality of computers each having a local memory and each being interconnected via a communications network wherein different portions of at least one application program each written to execute on only a single computer, each execute substantially simultaneously on a corresponding one of said plurality of computers, and at least one memory location is replicated in the local memory of each said computer, said system further comprising updating means associated with each said computer to in due course update each said memory location via said communications network after each occasion at which each said memory location has its content written to, or re-written, with a new content,

said single computer comprising:

a local memory having at least one memory location intended to be updated via a communications port connectable to said communications network,

updating means to in due course update the memory locations of other substantially similar computers via said communications port; lock means associated with said local memory to acquire a lock on an object, asset or resource of said local memory, a computer failure detector to detect failure of another computer, and release means to release any lock acquired but not released by a failed computer, whereby said application program portion executing on said single computer can acquire said lock of failed computers in due course, if necessary.

In accordance with a fourth aspect of the present invention there is disclosed a computer program product comprising a set of program instructions stored in a storage medium and operable to permit a plurality of computers to carry out the above defined method.

In accordance with a fifth aspect of the present invention there is disclosed a plurality of computers interconnected via a communications network and operable to ensure carrying out of the above described method.

In accordance with a sixth aspect of the present invention there is disclosed an application program stored in a computer readable medium and modified to carry out the above described method.

In accordance with a seventh aspect of the present invention there is disclosed in a single computer capable of interoperating with at least one other computer coupled to said single computer at least intermittently via a communications network to form a multiple computer system having a plurality of computers wherein each computer has a local memory, a method for handling a lock of an object, asset, or resource comprising:

executing at least a portion of at least one application program written to execute on only a single computer and modified to execute substantially simultaneously on one of said plurality of computers;

replicating at least one memory location in the local memory of each of said plurality of computers;

updating each said memory location of said other computer in due course via said communications network after each occasion at which a memory location has a memory content written to, or re-written, with a new content;

acquiring a lock on an object, asset or resource of said local memory;

detecting a failure of another computer, and

releasing any lock acquired but not released by a failed computer, so that said application program portion executing on said single computer can acquire said lock of failed computers in due course.

In accordance with an eighth aspect of the present invention there is disclosed a computer program recorded on a memory device comprising instructions which, when executed on a computer, perform in at least one single computer capable of interoperating with at least one other computer coupled to said single computer at least intermittently via a communications network to form a multiple computer system having a plurality of computers wherein each computer has a local memory, a method for handling a lock of an object, asset, or resource, said method comprising the steps of:

replicating at least one memory location in the local memory of each of said plurality of computers;

updating each said memory location of said other computer in due course via said communications network after each occasion at which a memory location has a memory content written to, or re-written, with a new content;

acquiring a lock on an object, asset or resource of said local memory;

detecting a failure of another computer, and

releasing any lock acquired but not released by a failed computer, so that said application program portion executing on said single computer can acquire said lock of failed computers in due course.

### BRIEF DESCRIPTION OF THE DRAWINGS

Some embodiments of the present invention will now be described with reference to the drawings in which:

FIG. 1A is a schematic illustration of a prior art computer arranged to operate JAVA code and thereby constitute a single JAVA virtual machine,

FIG. 1B is a drawing similar to FIG. 1A but illustrating the initial loading of code,

FIG. 1C illustrates the interconnection of a multiplicity of computers each being a JAVA virtual machine to form a multiple computer system,

FIG. 2 schematically illustrates “n” application running computers to which at least one additional server machine X is connected as a lock synchronizing server,

FIGS. 3 and 4 respectively illustrate the steps carried out by any machine Mn to acquire and release a lock in accordance with a first embodiment,

FIGS. 5 and 6 respectively illustrate the steps carried out by the lock server machine MX corresponding to FIGS. 3 and 4,

FIG. 7 illustrates the steps carried out by lock server machine MX in accordance with the first embodiment following failure of a machine Mn,

FIGS. 8 and 9 respectively illustrate the steps carried out by a lock requesting machine and the lock server machine MX in accordance with a second embodiment following failure of another, lock holding, machine.

### DETAILED DESCRIPTION

The embodiments will be described with reference to the JAVA language, however, it will be apparent to those skilled in the art that the invention is not limited to this language and, in particular can be used with other languages (including procedural, declarative and object oriented languages) including the MICROSOFT.NET platform and architecture (Visual Basic, Visual C, and Visual C++, and Visual C#), FORTRAN, C, C++, COBOL, BASIC and the like.

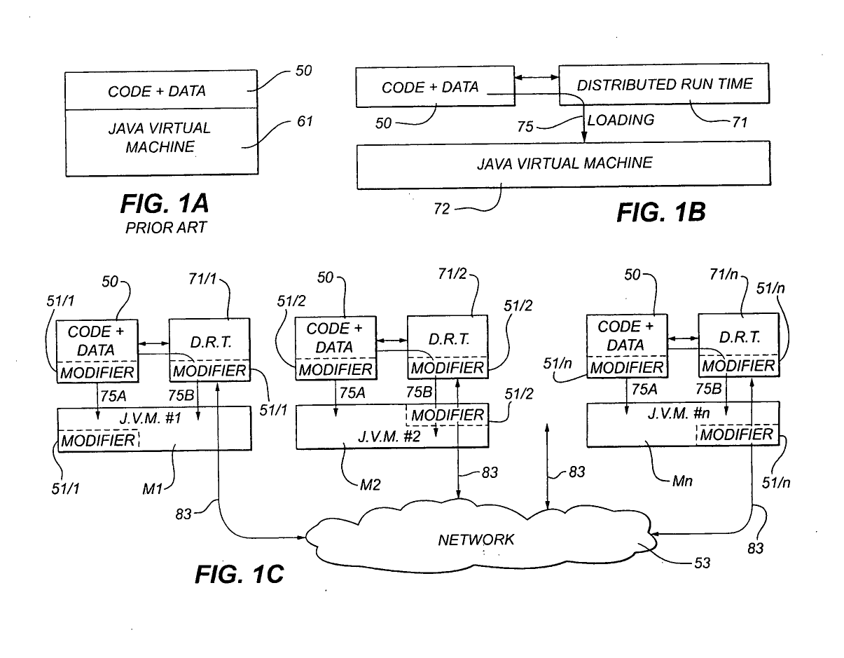

It is known in the prior art to provide a single computer or machine (produced by any one of various manufacturers and having an operating system (or equivalent control software or other mechanism) operating in any one of various different languages) utilizing the particular language of the application by creating a virtual machine as illustrated in FIG. 1A.

The code and data and virtual machine configuration or arrangement of FIG. 1A takes the form of the application code 50 written in the JAVA language and executing within the JAVA virtual machine 61. Thus where the intended language of the application is the language JAVA, a JAVA virtual machine is used which is able to operate code in JAVA irrespective of the machine manufacturer and internal details of the computer or machine. For further details, see “The JAVA Virtual Machine Specification” 2^{nd} Edition by T. Lindholm and F. Yellin of Sun Microsystems Inc of the USA which is incorporated herein by reference.

This conventional art arrangement of FIG. 1A is modified in accordance with embodiments of the present invention by the provision of an additional facility which is conveniently termed a “distributed run time” or a “distributed run time system” DRT 71 and as seen in FIG. 1B.

In FIGS. 1B and 1C, the application code 50 is loaded onto the Java Virtual Machine(s) M1, M2, . . . Mn in cooperation with the distributed runtime system 71, through the loading procedure indicated by arrow 75 or 75A or 75B. As used herein the terms “distributed runtime” and the “distributed run time system” are essentially synonymous, and by means of illustration but not limitation are generally understood to include library code and processes which support software written in a particular language running on a particular platform. Additionally, a distributed runtime system may also include library code and processes which support software written in a particular language running within a particular distributed computing environment. A runtime system (whether a distributed runtime system or not) typically deals with the details of the interface between the program and the operating system such as system calls, program start-up and termination, and memory management. For purposes of background, a conventional Distributed Computing Environment (DCE) (that does not provide the capabilities of the inventive distributed run time or distributed run time system 71 used in the preferred embodiments of the present invention) is available from the Open Software Foundation. This Distributed Computing Environment (DCE) performs a form of computer-to-computer communication for software running on the machines, but among its many limitations, it is not able to implement the desired modification or communication operations. Among its functions and operations the preferred DRT 71 coordinates the particular communications between the plurality of machines M1, M2, . . . Mn. Moreover, the preferred distributed runtime 71 comes into operation during the loading procedure indicated by arrow 75A or 75B of the JAVA application 50 on each JAVA virtual machine 72 or machines JVM#1, JVM#2, . . . JVM#n of FIG. 1C. It will be appreciated in light of the description provided herein that although many examples and descriptions are provided relative to the JAVA language and JAVA virtual machines so that the reader may get the benefit of specific examples, the invention is not restricted to either the JAVA language or JAVA virtual machines, or to any other language, virtual machine, machine or operating environment.

FIG. 1C shows in modified form the arrangement of the JAVA virtual machines, each as illustrated in FIG. 1B. It will be apparent that again the same application code 50 is loaded onto each machine M1, M2 . . . Mn. However, the communications between each machine M1, M2 . . . Mn are as indicated by arrows 83, and although physically routed through the machine hardware, are advantageously controlled by the individual DRT's 71/1 . . . 71/n within each machine. Thus, in practice this may be conceptionalised as the DRT's 71/1, . . . 71/n communicating with each other via the network or other communications link 53 rather than the machines M1, M2 . . . Mn communicating directly themselves or with each other. Contemplated and included are either this direct communication between machines M1, M2 . . . Mn or DRT's 71/1, 71/2 . . . 71/n or a combination of such communications. The preferred DRT 71 provides communication that is transport, protocol, and link independent.

The one common application program or application code 50 and its executable version (with likely modification) is simultaneously or concurrently executing across the plurality of computers or machines M1, M2 . . . Mn. The application program 50 is written to execute on a single machine or computer (or to operate on the multiple computer system of the abovementioned patent applications which emulate single computer operation). Essentially the modified structure is to replicate an identical memory structure and contents on each of the individual machines.

The term “common application program” is to be understood to mean an application program or application program code written to operate on a single machine, and loaded and/or executed in whole or in part on each one of the plurality of computers or machines M1, M2 . . . Mn, or optionally on each one of some subset of the plurality of computers or machines M1, M2 . . . Mn. Put somewhat differently, there is a common application program represented in application code 50. This is either a single copy or a plurality of identical copies each individually modified to generate a modified copy or version of the application program or program code. Each copy or instance is then prepared for execution on the corresponding machine. At the point after they are modified they are common in the sense that they perform similar operations and operate consistently and coherently with each other. It will be appreciated that a plurality of computers, machines, information appliances, or the like implementing embodiments of the invention may optionally be connected to or coupled with other computers, machines, information appliances, or the like that do not implement embodiments of the invention.

The same application program 50 (such as for example a parallel merge sort, or a computational fluid dynamics application or a data mining application) is run on each machine, but the executable code of that application program is modified on each machine as necessary such that each executing instance (copy or replica) on each machine coordinates its local operations on that particular machine with the operations of the respective instances (or copies or replicas) on the other machines such that they function together in a consistent, coherent and coordinated manner and give the appearance of being one global instance of the application (i.e. a “meta-application”).

The copies or replicas of the same or substantially the same application codes, are each loaded onto a corresponding one of the interoperating and connected machines or computers. As the characteristics of each machine or computer may differ, the application code 50 may be modified before loading, or during the loading process, or with some disadvantages after the loading process, to provide a customization or modification of the application code on each machine. Some dissimilarity between the programs or application codes on the different machines may be permitted so long as the other requirements for interoperability, consistency, and coherency as described herein can be maintained. As it will become apparent hereafter, each of the machines M1, M2 . . . Mn and thus all of the machines M1, M2 . . . Mn have the same or substantially the same application code 50, usually with a modification that may be machine specific.

Before the loading of, or during the loading of, or at any time preceding the execution of, the application code 50 (or the relevant portion thereof) on each machine M1, M2 . . . Mn, each application code 50 is modified by a corresponding modifier 51 according to the same rules (or substantially the same rules since minor optimizing changes are permitted within each modifier 51/1, 51/2 . . . 51/n).

Each of the machines M1, M2 . . . Mn operates with the same (or substantially the same or similar) modifier 51 (in some embodiments implemented as a distributed run time or DRT71 and in other embodiments implemented as an adjunct to the application code and data 50, and also able to be implemented within the JAVA virtual machine itself). Thus all of the machines M1, M2 . . . Mn have the same (or substantially the same or similar) modifier 51 for each modification required. A different modification, for example, may be required for memory management and replication, for initialization, for finalization, and/or for synchronization (though not all of these modification types may be required for all embodiments).

There are alternative implementations of the modifier 51 and the distributed run time 71. For example, as indicated by broken lines in FIG. 1C, the modifier 51 may be implemented as a component of or within the distributed run time 71, and therefore the DRT 71 may implement the functions and operations of the modifier 51. Alternatively, the function and operation of the modifier 51 may be implemented outside of the structure, software, firmware, or other means used to implement the DRT 71 such as within the code and data 50, or within the JAVA virtual machine itself. In one embodiment, both the modifier 51 and DRT 71 are implemented or written in a single piece of computer program code that provides the functions of the DRT and modifier. In this case the modifier function and structure is, in practice, subsumed into the DRT. Independent of how it is implemented, the modifier function and structure is responsible for modifying the executable code of the application code program, and the distributed run time function and structure is responsible for implementing communications between and among the computers or machines. The communications functionality in one embodiment is implemented via an intermediary protocol layer within the computer program code of the DRT on each machine. The DRT can, for example, implement a communications stack in the JAVA language and use the Transmission Control Protocol/Internet Protocol (TCP/IP) to provide for communications or talking between the machines. These functions or operations may be implemented in a variety of ways, and it will be appreciated in light of the description provided herein that exactly how these functions or operations are implemented or divided between structural and/or procedural elements, or between computer program code or data structures, is not important or crucial to the invention.

However, in the arrangement illustrated in FIG. 1C, a plurality of individual computers or machines M1, M2 . . . Mn are provided, each of which are interconnected via a communications network 53 or other communications link. Each individual computer or machine is provided with a corresponding modifier 51. Each individual computer is also provided with a communications port which connects to the communications network. The communications network 53 or path can be any electronic signalling, data, or digital communications network or path and is preferably a slow speed, and thus low cost, communications path, such as a network connection over the Internet or any common networking configurations including ETHERNET or INFINIBAND and extensions and improvements, thereto. Preferably, the computers are provided with one or more known communications ports (such as CISCO Power Connect 5224 Switches) which connect with the communications network 53.

As a consequence of the above described arrangement, if each of the machines M1, M2, . . . , Mn has, say, an internal or local memory capability of 10 MB, then the total memory available to the application code 50 in its entirety is not, as one might expect, the number of machines (n) times 10 MB. Nor is it the additive combination of the internal memory capability of all n machines. Instead it is either 10 MB, or some number greater than 10 MB but less than n×10 MB. In the situation where the internal memory capacities of the machines are different, which is permissible, then in the case where the internal memory in one machine is smaller than the internal memory capability of at least one other of the machines, then the size of the smallest memory of any of the machines may be used as the maximum memory capacity of the machines when such memory (or a portion thereof) is to be treated as ‘common’ memory (i.e. similar equivalent memory on each of the machines M1 . . . Mn) or otherwise used to execute the common application code.

However, even though the manner that the internal memory of each machine is treated may initially appear to be a possible constraint on performance, how this results in improved operation and performance will become apparent hereafter. Naturally, each machine M1, M2 . . . Mn has a private (i.e. ‘non-common’) internal memory capability. The private internal memory capability of the machines M1, M2, . . . Mn are normally approximately equal but need not be. For example, when a multiple computer system is implemented or organized using existing computers, machines, or information appliances, owned or operated by different entities, the internal memory capabilities may be quite different. On the other hand, if a new multiple computer system is being implemented, each machine or computer is preferably selected to have an identical internal memory capability, but this need not be so.

It is to be understood that the independent local memory of each machine represents only that part of the machine's total memory which is allocated to that portion of the application program running on that machine. Thus, other memory will be occupied by the machine's operating system and other computational tasks unrelated to the application program 50.

Non-commercial operation of a prototype multiple computer system indicates that not every machine or computer in the system utilises or needs to refer to (e.g. have a local replica of) every possible memory location. As a consequence, it is possible to operate a multiple computer system without the local memory of each machine being identical to every other machine, so long as the local memory of each machine is sufficient for the operation of that machine. That is to say, provided a particular machine does not need to refer to (for example have a local replica of) some specific memory locations, then it does not matter that those specific memory locations are not replicated in that particular machine.

It may also be advantageous to select the amounts of internal memory in each machine to achieve a desired performance level in each machine and across a constellation or network of connected or coupled plurality of machines, computers, or information appliances M1, M2, . . . , Mn. Having described these internal and common memory considerations, it will be apparent in light of the description provided herein that the amount of memory that can be common between machines is not a limitation.

In some embodiments, some or all of the plurality of individual computers or machines can be contained within a single housing or chassis (such as so-called “blade servers” manufactured by Hewlett-Packard Development Company, Intel Corporation, IBM Corporation and others) or the multiple processors (eg symmetric multiple processors or SMPs) or multiple core processors (eg dual core processors and chip multithreading processors) manufactured by Intel, AMD, or others, or implemented on a single printed circuit board or even within a single chip or chip set. Similarly, also included are computers or machines having multiple cores, multiple CPU's or other processing logic.

When implemented in a non-JAVA language or application code environment, the generalized platform, and/or virtual machine and/or machine and/or runtime system is able to operate application code 50 in the language(s) (possibly including for example, but not limited to any one or more of source-code languages, intermediate-code languages, object-code languages, machine-code languages, and any other code languages) of that platform and/or virtual machine and/or machine and/or runtime system environment, and utilize the platform, and/or virtual machine and/or machine and/or runtime system and/or language architecture irrespective of the machine or processor manufacturer and the internal details of the machine. It will also be appreciated that the platform and/or runtime system can include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the inventive structure, method and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the Power PC computer architecture manufactured by International Business Machines Corporation and others, and the personal computer products made by Apple Computer, Inc., and others.

For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records), derived types, or other code or data structures of procedural languages or other languages and environments such as functions, pointers, components, modules, structures, reference and unions. These structures and procedures when applied in combination when required, maintain a computing environment where memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

This analysis or scrutiny of the application code 50 can take place either prior to loading the application program code 50, or during the application program code 50 loading procedure, or even after the application program code 50 loading procedure (or some combination of these). It may be likened to an instrumentation, program transformation, translation, or compilation procedure in that the application code can be instrumented with additional instructions, and/or otherwise modified by meaning-preserving program manipulations, and/or optionally translated from an input code language to a different code language (such as for example from source-code language or intermediate-code language to object-code language or machine-code language). In this connection it is understood that the term compilation normally or conventionally involves a change in code or language, for example, from source code to object code or from one language to another language. However, in the present instance the term “compilation” (and its grammatical equivalents) is not so restricted and can also include or embrace modifications within the same code or language. For example, the compilation and its equivalents are understood to encompass both ordinary compilation (such as for example by way of illustration but not limitation, from source-code to object code), and compilation from source-code to source-code, as well as compilation from object-code to object code, and any altered combinations therein. It is also inclusive of so-called “intermediary-code languages” which are a form of “pseudo object-code”.

By way of illustration and not limitation, in one embodiment, the analysis or scrutiny of the application code 50 takes place during the loading of the application program code such as by the operating system reading the application code 50 from the hard disk or other storage device, medium or source and copying it into memory and preparing to begin execution of the application program code. In another embodiment, in a JAVA virtual machine, the analysis or scrutiny may take place during the class loading procedure of the java.lang.ClassLoader.loadClass method (e.g. “java.lang.ClassLoader.loadClass( )”).

Alternatively, or additionally, the analysis or scrutiny of the application code 50 (or of a portion of the application code) may take place even after the application program code loading procedure, such as after the operating system has loaded the application code into memory, or optionally even after execution of the relevant corresponding portion of the application program code has started, such as for example after the JAVA virtual machine has loaded the application code into the virtual machine via the “java.lang.ClassLoader.loadClass( )” method and optionally commenced execution.

Persons skilled in the computing arts will be aware of various possible techniques that may be used in the modification of computer code, including but not limited to instrumentation, program transformation, translation, or compilation means and/or methods.

One such technique is to make the modification(s) to the application code, without a preceding or consequential change of the language of the application code. Another such technique is to convert the original code (for example, JAVA language source-code) into an intermediate representation (or intermediate-code language, or pseudo code), such as JAVA byte code. Once this conversion takes place the modification is made to the byte code and then the conversion may be reversed. This gives the desired result of modified JAVA code.

A further possible technique is to convert the application program to machine code, either directly from source-code or via the abovementioned intermediate language or through some other intermediate means. Then the machine code is modified before being loaded and executed. A still further such technique is to convert the original code to an intermediate representation, which is thus modified and subsequently converted into machine code.

The present invention encompasses all such modification routes and also a combination of two, three or even more, of such routes.

The DRT 71 or other code modifying means is responsible for creating or replicating a memory structure and contents on each of the individual machines M1, M2 . . . Mn that permits the plurality of machines to interoperate. In some embodiments this replicated memory structure will be identical. Whilst in other embodiments this memory structure will have portions that are identical and other portions that are not. In still other embodiments the memory structures are different only in format or storage conventions such as Big Endian or Little Endian formats or conventions.

These structures and procedures when applied in combination when required, maintain a computing environment where the memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

Therefore the terminology “one”, “single”, and “common” application code or program includes the situation where all machines M1, M2. Mn are operating or executing the same program or code and not different (and unrelated) programs, in other words copies or replicas of same or substantially the same application code are loaded onto each of the interoperating and connected machines or computers.

In conventional arrangements utilising distributed software, memory access from one machine's software to memory physically located on another machine typically takes place via the network interconnecting the machines. Thus, the local memory of each machine is able to be accessed by any other machine and can therefore cannot be said to be independent. However, because the read and/or write memory access to memory physically located on another computer require the use of the slow network interconnecting the computers, in these configurations such memory accesses can result in substantial delays in memory read/write processing operations, potentially of the order of 10⁶-10⁷ cycles of the central processing unit of the machine (given contemporary processor speeds). Ultimately this delay is dependent upon numerous factors, such as for example, the speed, bandwidth, and/or latency of the communication network. This in large part accounts for the diminished performance of the multiple interconnected machines in the prior art arrangement.

However, in the present arrangement all reading of memory locations or data is satisfied locally because a current value of all (or some subset of all) memory locations is stored on the machine carrying out the processing which generates the demand to read memory.

Similarly, all writing of memory locations or data is satisfied locally because a current value of all (or some subset of all) memory locations is stored on the machine carrying out the processing which generates the demand to write to memory.

Such local memory read and write processing operation can typically be satisfied within 10²-10³ cycles of the central processing unit. Thus, in practice there is substantially less waiting for memory accesses which involves and/or writes. Also, the local memory of each machine is not able to be accessed by any other machine and can therefore be said to be independent.

The invention is transport, network, and communications path independent, and does not depend on how the communication between machines or DRTs takes place. In one embodiment, even electronic mail (email) exchanges between machines or DRTs may suffice for the communications.

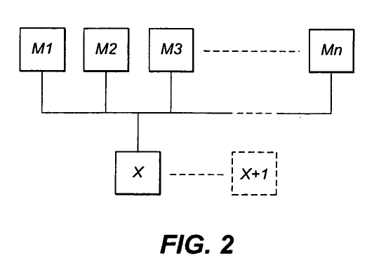

In connection with the above, it will be seen from FIG. 2 that there are a number of machines M1, M2, . . . Mn, “n” being an integer greater than or equal to two, on which the application program 50 of FIG. 1 is being run substantially simultaneously. These machines are allocated a number 1, 2, 3, . . . etc. in a hierarchical order. This order is normally looped or closed so that whilst machines 2 and 3 are hierarchically adjacent, so too are machines “n” and 1. There is preferably a further machine X which is provided to enable various housekeeping functions to be carried out, such as acting as a lock server. In particular, the further machine X can be a low value machine, and much less expensive than the other machines which can have desirable attributes such as processor speed. Furthermore, an additional low value machine (X+1) is preferably available to provide redundancy in case machine X should fail. Where two such server machines X and X+1 are provided, they are preferably, for reasons of simplicity, operated as dual machines in a cluster configuration. Machines X and X+1 could be operated as a multiple computer system in accordance with the present invention, if desired. However this would result in generally undesirable complexity. If the machine X is not provided then its functions, such as housekeeping functions, are provided by one, or some, or all of the other machines.

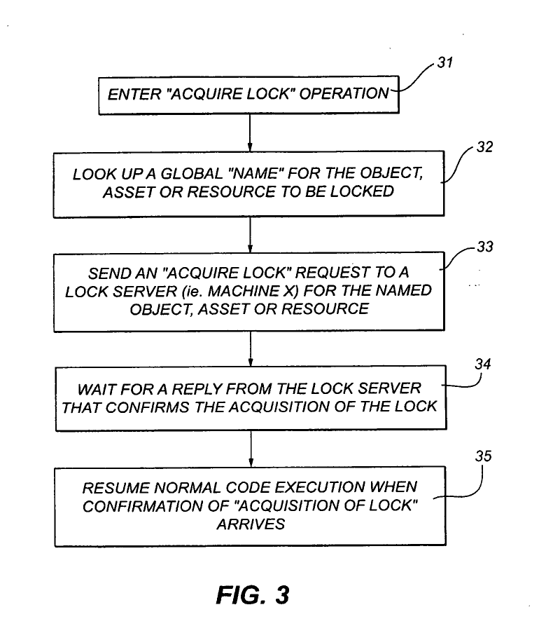

Turning now to FIG. 3, the operation of one of the machines M1-Mn on acquiring a lock is illustrated. Upon entering the “acquire lock” operation, as indicated at step 31, the acquiring machine, say M3, which is to acquire the lock looks up a global name for the object, asset or resource to be locked. For the purposes of this example, it will be assumed that the object, asset or resource is a memory location. Thus at step 32, the global name of the memory location is looked up, bearing in mind that each of the machines M1-Mn has a corresponding local memory location which will have the same global name, but possibly a different local name, depending upon the organisation of the local memory of each machine.

Firstly, the structures, assets or resources (in JAVA termed classes or objects) to be synchronized or locked have already been allocated a name or tag which can be used globally by all machines, as indicated by step 32. This preferably happens when the classes or objects are originally initialized. This is most conveniently done via a table (or list or like data structure the format of which is not critical) maintained by server machine X. This table also includes the identity of the machine receiving the lock, and the synchronization status of the class or object. In one embodiment, this table also includes a queue arrangement which stores the identities of machines which have requested use of this asset.

As indicated in step 33 of FIG. 3, next an “acquire lock” request is sent to machine X, after which, the sending machine M3 waits for confirmation of lock acquisition as shown in step 34. Thus, if the global name is already locked (ie the corresponding asset is in use by another machine other than the machine proposing to acquire the lock) then this means that the proposed synchronization routine of the object or class should be paused until the object or class is unlocked by the current owner.

Alternatively, if the global name is not locked, this means that no other machine is using this class or object, and confirmation of lock acquisition is received straight away. After receipt of confirmation of lock acquisition, execution of the synchronization routine is allowed to continue, as shown in step 35.

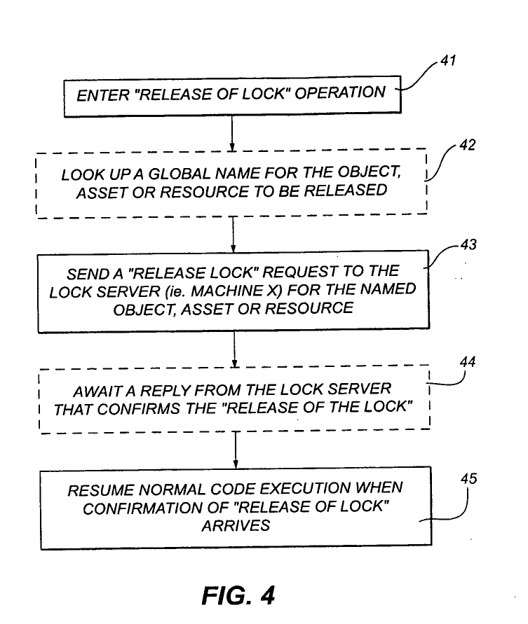

FIG. 4 shows the procedures followed by the application program executing machine M3 which wishes to relinquish a lock. The initial step is indicated at step 41. The operation of this proposing machine is temporarily interrupted by steps 43 and 44 until the reply is received from machine X, corresponding to step 44, and execution then resumes as indicated in step 45. Optionally, and as indicated by broken lines in step 42, the machine M3 requesting release of a lock is made to lookup the “global name” for this lock preceding a request being made to machine X. This way, multiple locks on multiple machines can be acquired and released without interfering with one another.

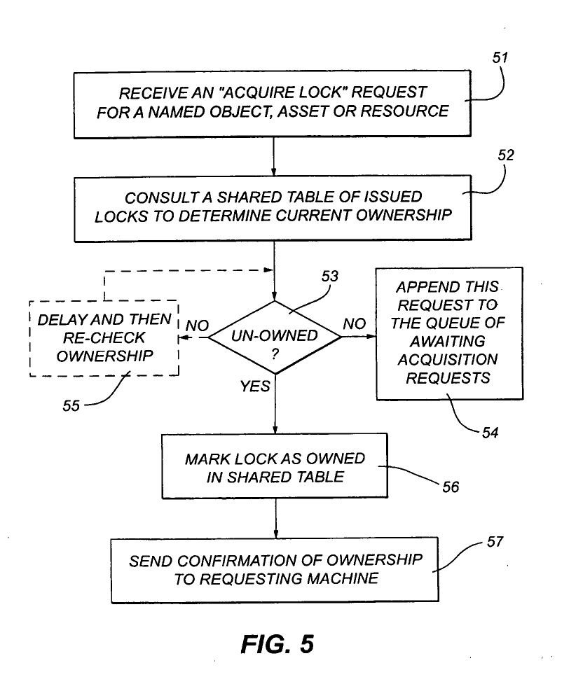

FIG. 5 shows the activity carried out by machine X in response to an “acquire lock” enquiry (of FIG. 3). After receiving an “acquire lock” request at step 51, the lock status is determined at steps 52 and 53 and, if no—the named resource is not free, the identity of the enquiring machine is added at step 54 to (or forms) the queue of awaiting acquisition requests. Alternatively, if the answer is yes—the named resource is free—the corresponding reply is sent at step 57. The waiting enquiring machine M3 is then able to execute the synchronization routine accordingly by carrying out step 35 of FIG. 3. In addition to the yes response, the shared table is updated at step 56 so that the status of the globally named asset is changed to “locked”, and the identity of the new lock owning machine is inserted in the table.

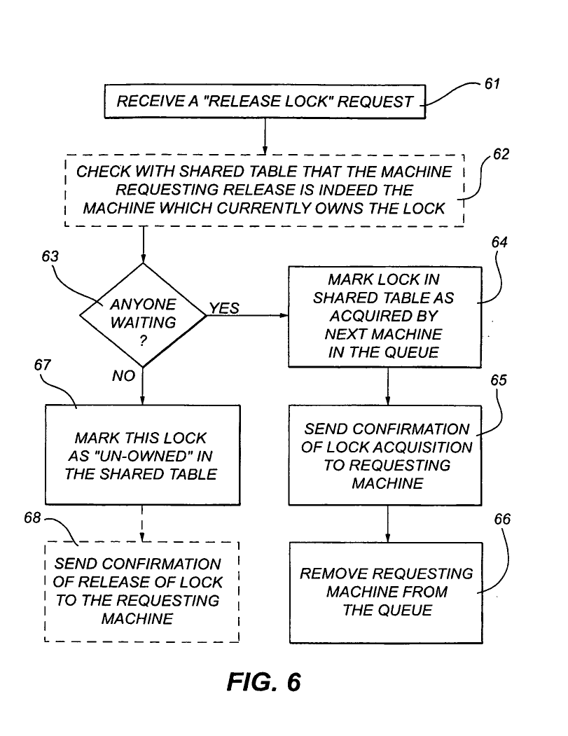

FIG. 6 shows the activity carried out by machine X in response to a “release lock” request of FIG. 4. After receiving a “release lock” request at step 61, machine X optionally, and preferably, confirms that the machine M3 requesting to release the lock is indeed the current owner of the lock”, as indicated in step 62. Next, the queue status is determined at step 63 and, if no machine is waiting to acquire this lock, machine X marks this lock as “unowned” in the shared table, as shown in step 67, and optionally sends a confirmation of release back to the requesting machine M3, as indicated by step 68. This enables the requesting machine M3 to execute step 45 of FIG. 4.

Alternatively, if yes—that is, one or more other machines are waiting to acquire this lock—machine X marks this lock as now acquired by the next machine in the queue, as shown in step 64, then sends a confirmation of lock acquisition to the queued machine at step 65, and consequently removes the new lock owner from the queue of waiting machines, as indicated in step 66.

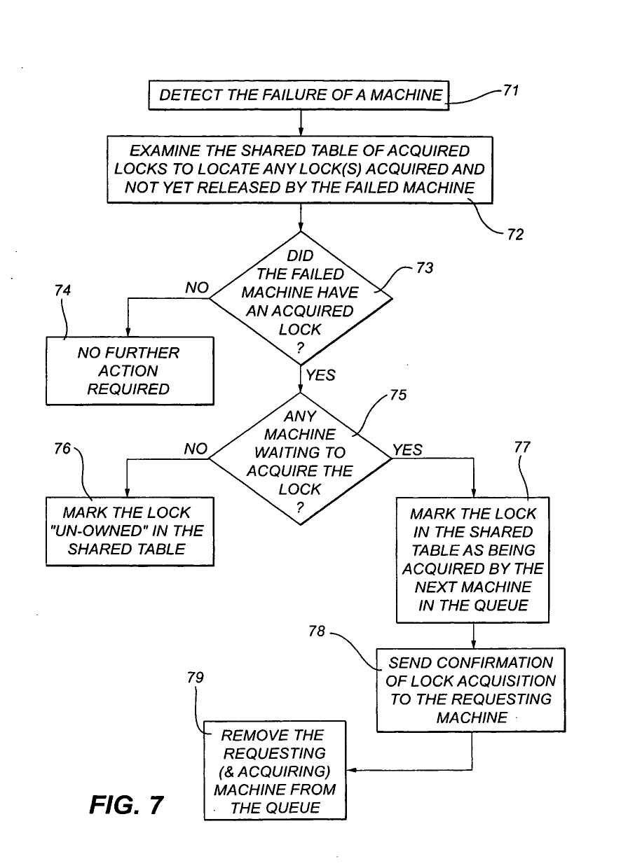

A first embodiment of what happens in the event that machine M3 fails whilst it has been allocated the lock, will now be described with reference to FIG. 7. Clearly, since machine M3 has failed, it cannot carry out step 43 of FIG. 4. Instead, machine X must detect for itself the failure of machine M3 as indicated by step 71 of FIG. 7. There are several ways in which machine X can detect failure of machine M3. The easiest is for machine X to regularly poll each of the machines M1, M2, . . . Mn in turn to question whether they are continuing to operate satisfactorily. Another method is to monitor traffic on the communications network 3 generated by each of the machines M1, M2, . . . Mn and destined for others of those machines. Other strategies will be apparent to those skilled in the computing arts and are described hereafter.

Next, the lock server machine X looks up the table of currently acquired locks to see if the failed machine M3 is listed therein. This is indicated at steps 72 and 73 of FIG. 7. If machine M3 is not listed in the table, then nothing further is required to be done, as indicated at step 74, since there is no lock which cannot be relinquished.

If, however, the answer to this enquiry is yes, then as indicated at step 75 in FIG. 7, a still further enquiry must be made, namely is there a machine (or a queue of machines) awaiting for this lock to be allocated to them. If the answer is no, then only relatively minor action is required (as indicated at step 76) in that the look up table must be amended to indicate that the specific lock is now unallocated (and thus available in the event of a further “acquire lock” request).

However, in the event that the latest enquiry reveals at least one waiting machine, then action equivalent to a pseudo “release lock” request from the now defunct machine M3 is required. This is indicated in steps 77-79 in FIG. 7. First, the look up table is amended as indicated in step 77, to show that the waiting machine, say machine M7, (or one of the waiting machines) has acquired the lock.

Next, machine X generates the confirmation of lock ownership message of step 57 of FIG. 5 and (as indicated in step 78 of FIG. 7) sends this to the waiting machine M7. Finally, as indicated in step 79 of FIG. 7, machine M7 (having just acquired the lock) is now removed from the queue of waiting machines.

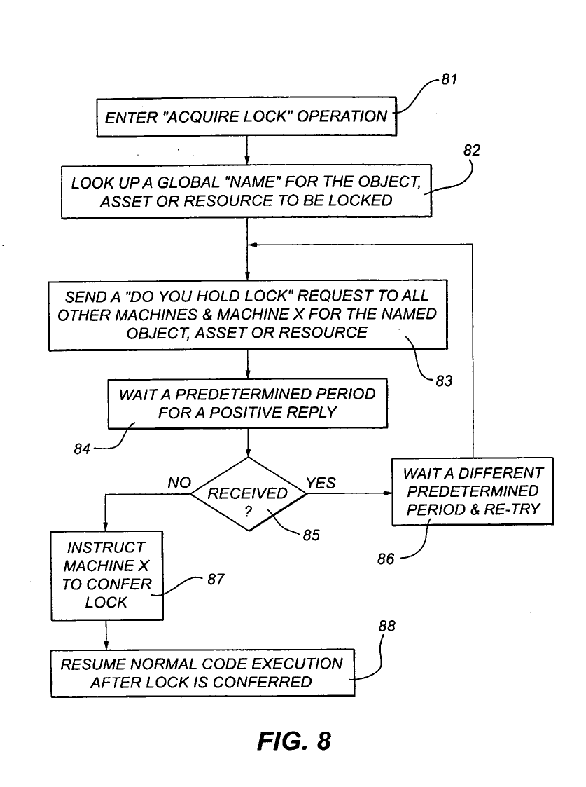

In a second embodiment illustrated in FIG. 8, the machine, say machine M7, wishing to acquire the lock repeats steps 31 and 32 of FIG. 3 (illustrated as steps 81 and 82 in FIG. 8). However, machine M7 then carries out step 83 in FIG. 8 by sending a “DO YOU HOLD LOCK” request, which names the desired object, asset or resource to be locked, to all the other machines M1, M2, . . . M6, M8, . . . Mn and X. Machine M7 then waits for a short predetermined period to see if any positive reply is received. If so, machine M7 then waits for a relatively long predetermined period and then retries by sending out another request (as indicated by steps 84, 85 and 86 of FIG. 8).

In the alternative, if no positive reply is received within the short predetermined period, machine M7 then instructs machine X to confer the lock upon it (as indicated by steps 84, 85 and 87 in FIG. 8). Once machine X confers the lock, machine M7 resumes normal processing.

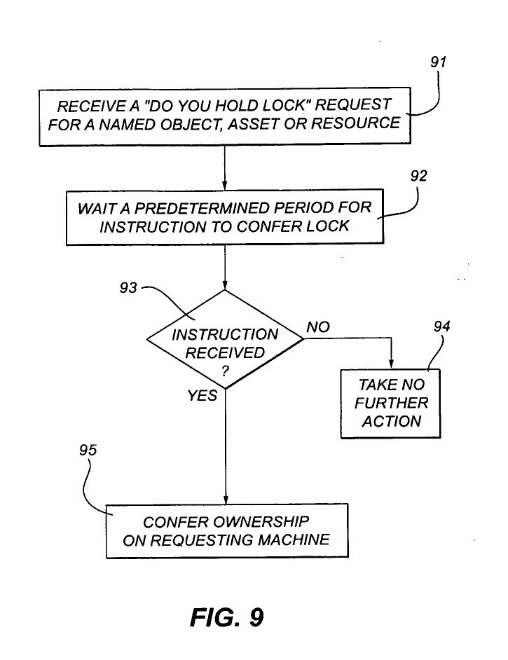

The corresponding actions taken by machine X are illustrated in FIG. 9. Firstly, at step 91 machine X receives the “DO YOU HOLD LOCK” request in respect of the named asset. The machine X waits for a period consistent with the expected time for replies to be received by machine M7. If nothing further is received by machine X within the expected time, machine X takes no further action (as indicated by steps 92, 93 and 94 in FIG. 9).

In the alternative, if the instruction to confer the lock is received from machine M7, then machine X confers ownership of the lock on machine M7 (thereby carrying out steps 92, 93 and 95 of FIG. 9).

The above described second embodiment works in the following way in the event of machine failure. Say machine M6 has had conferred on it the lock in question, and machine M6 fails. Then when M7 asks machine M6 if it has the lock (either initially or as a consequence eventually of a retry by machine M7) machine M7 does not receive a positive reply from machine M6 (which having failed gives no reply —either positive or negative). Thus step 87 of FIG. 8 is triggered and the lock previously conferred on the failed machine M6 is now conferred on a requesting machine M7. So the overall system is able to carry on, notwithstanding the failure of machine M6.

The abovementioned machine failure can occur in any one (or more) of a number of different modes (for example due to failure of its power supply, CPU, failure of its link to the network 53 or similar catastrophic failure). This failure is able to be detected by a conventional detector attached to each of the application program running machines and reporting to machine X, for example.

Such a detector is commercially available as a Simple Network Management Protocol (SNMP). This is essentially a small program which operates in the background and provides a specified output signal in the event that failure is detected.

Such a detector is able to sense failure in a number of ways, any one, or more, of which can be used simultaneously. For example, machine X can interrogate each of the other machines M1, . . . Mn in turn requesting a reply. If no reply is forthcoming after a predetermined time, or after a small number of “reminders” are sent, also without reply, the non-responding machine is pronounced “dead”.

Alternatively, or additionally, each of the machines M1, . . . Mn can at regular intervals, say every 30 seconds, send a predetermined message to machine X (or to all other machines in the absence of a server) to say that all is well. In the absence of such a message the machine can be presumed “dead” or can be interrogated (and if it then fails to respond) is pronounced “dead”.

Further methods include looking for a turn on event in an uninterruptible power supply (UPS) used to power each machine which therefore indicates a failure of mains power. Similarly conventional switches such as those manufactured by CISCO of California, USA include a provision to check either the presence of power to the communications network 53, or whether the network cable is disconnected.

In some circumstances, for example for enhanced redundancy or for increased bandwidth, each individual machine can be “multi-peered” which means there are two or more links between the machine and the communications network 3. An SNMP product which provides two options in this circumstance—namely wait for both/all links to fail before signalling machine failure, or signal machine failure if any one link fails, is the 12 Port Gigabit Managed Switch GSM 7212 sold under the trade marks NETGEAR and PROSAFE.

The foregoing describes only some embodiments of the present invention and modifications, obvious to those skilled in the art, can be made thereto without departing from the scope of the present invention. For example, reference to JAVA includes both the JAVA language and also JAVA platform and architecture.

In all described instances of modification, where the application code 50 is modified before, or during loading, or even after loading but before execution of the unmodified application code has commenced, it is to be understood that the modified application code is loaded in place of, and executed in place of, the unmodified application code subsequently to the modifications being performed.

Alternatively, in the instances where modification takes place after loading and after execution of the unmodified application code has commenced, it is to be understood that the unmodified application code may either be replaced with the modified application code in whole, corresponding to the modifications being performed, or alternatively, the unmodified application code may be replaced in part or incrementally as the modifications are performed incrementally on the executing unmodified application code. Regardless of which such modification routes are used, the modifications subsequent to being performed execute in place of the unmodified application code.

It is advantageous to use a global identifier is as a form of ‘meta-name’ or ‘meta-identity’ for all the similar equivalent local objects (or classes, or assets or resources or the like) on each one of the plurality of machines M1, M2 . . . Mn. For example, rather than having to keep track of each unique local name or identity of each similar equivalent local object on each machine of the plurality of similar equivalent objects, one may instead define or use a global name corresponding to the plurality of similar equivalent objects on each machine (e.g. “globalname7787”), and with the understanding that each machine relates the global name to a specific local name or object (e.g. “globalname7787” corresponds to object “localobject456” on machine M1, and “globalname7787” corresponds to object “localobject885” on machine M2, and “globalname7787” corresponds to object “localobject111” on machine M3, and so forth).

It will also be apparent to those skilled in the art in light of the detailed description provided herein that in a table or list or other data structure created by each DRT 71 when initially recording or creating the list of all, or some subset of all objects (e.g. memory locations or fields), for each such recorded object on each machine M1, M2 . . . Mn there is a name or identity which is common or similar on each of the machines M1, M2 . . . Mn. However, in the individual machines the local object corresponding to a given name or identity will or may vary over time since each machine may, and generally will, store memory values or contents at different memory locations according to its own internal processes. Thus the table, or list, or other data structure in each of the DRTs will have, in general, different local memory locations corresponding to a single memory name or identity, but each global “memory name” or identity will have the same “memory value or content” stored in the different local memory locations. So for each global name there will be a family of corresponding independent local memory locations with one family member in each of the computers. Although the local memory name may differ, the asset, object, location etc has essentially the same content or value. So the family is coherent.

The term “table” or “tabulation” as used herein is intended to embrace any list or organised data structure of whatever format and within which data can be stored and read out in an ordered fashion.

It will also be apparent to those skilled in the art in light of the description provided herein that the abovementioned modification of the application program code 50 during loading can be accomplished in many ways or by a variety of means. These ways or means include, but are not limited to at least the following five ways and variations or combinations of these five, including by:

(i) re-compilation at loading,

(ii) a pre-compilation procedure prior to loading,

(iii) compilation prior to loading,

(iv) “just-in-time” compilation(s), or

(v) re-compilation after loading (but, for example, before execution of the relevant or corresponding application code in a distributed environment).

Traditionally the term “compilation” implies a change in code or language, for example, from source to object code or one language to another. Clearly the use of the term “compilation” (and its grammatical equivalents) in the present specification is not so restricted and can also include or embrace modifications within the same code or language.

Given the fundamental concept of modifying memory manipulation operations to coordinate operation between and amongst a plurality of machines M1, M2 . . . Mn, there are several different ways or embodiments in which this coordinated, coherent and consistent memory state and manipulation operation concept, method, and procedure may be carried out or implemented.

In the first embodiment, a particular machine, say machine M2, loads the asset (such as class or object) inclusive of memory manipulation operation(s), modifies it, and then loads each of the other machines M1, M3 . . . Mn (either sequentially or simultaneously or according to any other order, routine or procedure) with the modified object (or class or other assert or resource) inclusive of the new modified memory manipulation operation. Note that there may be one or a plurality of memory manipulation operations corresponding to only one object in the application code, or there may be a plurality of memory manipulation operations corresponding to a plurality of objects in the application code. Note that in one embodiment, the memory manipulation operation(s) that is (are) loaded is executable intermediary code.

In this arrangement, which may be termed “master/slave” each of the slave (or secondary) machines M1, M3 . . . Mn loads the modified object (or class), and inclusive of the new modified memory manipulation operation(s), that was sent to it over the computer communications network or other communications link or path by the master (or primary) machine, such as machine M2, or some other machine as a machine X. In a slight variation of this “master/slave” or “primary/secondary” arrangement, the computer communications network can be replaced by a shared storage device such as a shared file system, or a shared document/file repository such as a shared database.

It will be appreciated in the light of the detailed description provided herein that the modification performed on each machine or computer need not and frequently will not be the same or identical. What is required is that they are modified in a similar enough way that each of the plurality of machines behaves consistently and coherently relative to the other machines. Furthermore, it will be appreciated that there are a myriad of ways to implement the modifications that may for example depend on the particular hardware, architecture, operating system, application program code, or the like or different factors. It will also be appreciated that implementation can be within an operating system, outside of or without the benefit of any operating system, inside the virtual machine, in an EPROM, in software, in hardware, in firmware, or in any combination of these.

In a still further embodiment, each machine M1, M2 . . . Mn receives the unmodified asset (such as class or object) inclusive of one or more memory manipulation operation(s), but modifies the operations and then loads the asset (such as class or object) consisting of the now modified operations. Although one machine, such as the master or primary machine may customize or perform a different modification to the memory manipulation operation(s) sent to each machine, this embodiment more readily enables the modification carried out by each machine to be slightly different. It can thereby be enhanced, customized, and/or optimized based upon its particular machine architecture, hardware processor, memory, configuration, operating system, or other factors yet still be similar, coherent and consistent with the other machines and with all other similar modifications.

In all of the described instances or embodiments, the supply or the communication of the asset code (such as class code or object code) to the machines M1, M2 . . . Mn and optionally inclusive of a machine X, can be branched, distributed or communication among and between the different machines in any combination or permutation; such as by providing direct machine to machine communication (for example, M2 supplies each of M1, M3, M4 etc. directly), or by providing or using cascaded or sequential communication (for example, M2 supplies M1 which then supplies M3 which then supplies M4, and so on) or a combination of the direct and cascaded and/or sequential.

The abovedescribed arrangement needs to be varied in the situation where the modification relates to a cleanup routine, finalization or similar, which is only to be carried out by one of the plurality of computers In this variation of this “master/slave” or “primary/secondary” arrangement, machine M2 loads the asset (such as class or object) inclusive of a cleanup routine in unmodified form on machine M2, and then (for example, M2 or each local machine) deletes the unmodified cleanup routine that had been present on the machine in whole or part from the asset (such as class or object) and loads by means of the computer communications network the modified code for the asset with the now modified or deleted cleanup routine on the other machines. Thus in this instance the modification is not a transformation, instrumentation, translation or compilation of the asset cleanup routine but a deletion of the cleanup routine on all machines except one. In one embodiment, the actual code-block of the finalization or cleanup routine is deleted on all machines except one, and this last machine therefore is the only machine that can execute the finalization routine because all other machines have deleted the finalization routine. One benefit of this approach is that no conflict arises between multiple machines executing the same finalization routine because only one machine has the routine.

The process of deleting the cleanup routine in its entirety can either be performed by the “master” machine (such as for example machine M2 or some other machine such as machine X) or alternatively by each other machine M1, M3 . . . Mn upon receipt of the unmodified asset. An additional variation of this “master/slave” or “primary/secondary” arrangement is to use a shared storage device such as a shared file system, or a shared document/file repository such as a shared database as means of exchanging the code for the asset, class or object between machines M1, M2 . . . Mn and optionally the server machine X.

In a further arrangement, a particular machine, say for example machine M1, loads the unmodified asset (such as class or object) inclusive of a finalization or cleanup routine and all the other machines M2, M3 . . . Mn perform a modification to delete the cleanup routine of the asset (such as class or object) and load the modified version.

In a still further arrangement, the machines M1, M2 . . . Mn, may send some or all load requests to the additional server machine X, which performs the modification to the application program code 50 (including or consisting of assets, and/or classes, and/or objects) and inclusive of finalization or cleanup routine(s), via any of the abovementioned methods, and returns in the modified application program code inclusive of the now modified finalization or cleanup routine(s) to each of the machines M1 to Mn, and these machines in turn load the modified application program code inclusive of the modified routine(s) locally. In this arrangement, machines M1 to Mn forward all load requests to machine X, which returns a modified application program code inclusive of modified finalization or cleanup routine(s) to each machine. The modifications performed by machine X can include any of the modifications described. This arrangement may of course be applied to some only of the machines whilst other arrangements described herein are applied to others of the machines.

Those skilled in the computer and/or programming arts will be aware that when additional code or instructions is/are inserted into an existing code or instruction set to modify same, the existing code or instruction set may well require further modification (such as for example, by re-numbering of sequential instructions) so that offsets, branching, attributes, mark up and the like are properly handled or catered for.

Similarly, in the JAVA language memory locations include, for example, both fields and array types. The above description deals with fields and the changes required for array types are essentially the same mutatis mutandis. Also the present invention is equally applicable to similar programming languages (including procedural, declarative and object orientated languages) to JAVA including Microsoft.NET platform and architecture (Visual Basic, Visual C/C++, and C#) FORTRAN, C/C++, COBOL, BASIC etc.

The terms object and class used herein are derived from the JAVA environment and are intended to embrace similar terms derived from different environments such as dynamically linked libraries (DLL), or object code packages, or function unit or memory locations.

Various means are described relative to embodiments of the invention, including for example but not limited to lock means, distributed run time means, modifier or modifying means, and the like. In at least one embodiment of the invention, any one or each of these various means may be implemented by computer program code statements or instructions (possibly including by a plurality of computer program code statements or instructions) that execute within computer logic circuits, processors, ASICs, logic or electronic circuit hardware, microprocessors, microcontrollers or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the abovedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer in which it executes or on a computer coupled with, connected to, or otherwise in signal communications with the computer on which the computer program or computer program product is present or executing. Such a computer program or computer program product modifies the operation and architectural structure of the computer, computing machine, and/or information appliance to alter the technical operation of the computer and realize the technical effects described herein.

The invention may therefore include a computer program product comprising a set of program instructions stored in a storage medium or existing electronically in any form and operable to permit a plurality of computers to carry out any of the methods, procedures, routines, or the like as described herein including in any of the claims.

Furthermore, the invention includes (but is not limited to) a plurality of computers, or a single computer adapted to interact with a plurality of computers, interconnected via a communication network or other communications link or path and each operable to substantially simultaneously or concurrently execute the same or a different portion of an application code written to operate on only a single computer on a corresponding different one of computers. The computers are programmed to carry out any of the methods, procedures, or routines described in the specification or set forth in any of the claims, on being loaded with a computer program product or upon subsequent instruction. Similarly, the invention also includes within its scope a single computer arranged to co-operate with like, or substantially similar, computers to form a multiple computer system

The term “compromising” (and its grammatical variations) as used herein is used in the inclusive sense of “having” or “including” and not in the exclusive sense of “consisting only of”.

Set out in the Annexure hereto, together with a brief explanatory passage, are code fragments which implement an embodiment of the present invention.

To summarise, there is disclosed in a multiple computer environment in which an application program written to execute only on a single computer runs simultaneously on a plurality of computers each of which has a local memory in which globally named objects, assets or resources are locally substantially replicated and in which a synchronizing lock corresponding to the global name is acquired and released in sequence by any computer utilizing one of the objects, assets or resources, the lock authorizing the acquiring computer to update the local contents of the locked object, asset or resource and preventing all other computers accessing their corresponding local object, asset or resource, the improvement comprising the step of: following computer failure of any computer which has acquired but not released any specific lock,

(i) releasing the specific lock, whereby the application program running conducted by the non-failed ones of the computers can continue by allocation of the lock to a non-failed one of the computers in due course, if necessary.

Preferably, at the time of the computer failure at least one other computer is awaiting allocation of the specific lock, the method comprising the further step of:

(ii) allocating the specific lock to the, or one of, the computer(s) awaiting allocation.

Preferably, the method comprises the further steps of:

(iii) detecting the computer failure,

(iv) determining whether the failed computer held any unreleased locks,

(v) determining the identity of the other computer(s) awaiting allocation, and

(vi) allocating the specific lock to the computer identified in step (v).

Preferably, the method comprises the further steps of:

(vii) maintaining a table of allocated locks which table includes the identity of the machine to which each lock has been allocated,

(viii) carrying out step (v) by consulting the table, and

(ix) updating the table after carrying out step (vi).

Alternatively, the method comprises the further steps of:

(x) requiring any lock requesting computer to interrogate each possible lock holding computer as to whether it holds the specific lock, and

(xi) utilizing the absence of a positive answer within a predetermined time to trigger allocation of the specific lock to the requesting computer whereby any lock holding computer which fails is incapable of the positive answer and thereby permits allocation of the lock to the lock requesting computer.

Preferably, the method comprises the further step of:

(xii) requiring the lock requesting computer to repeat step (x) after a predetermined delay following receipt of a positive answer to step (x).

In addition, there is also provided a multiple computer system in which an application program written to execute only on a single computer runs simultaneously on the multiple computers each of which has a local memory in which globally named objects, assets or resources are locally substantially replicated and in which a synchronizing lock corresponding to the global name is acquired and released in sequence by any computer utilizing one of the objects, assets or resources, the lock authorizing the acquiring computer to update the local contents of the locked object, asset or resource and preventing all other computers accessing their corresponding local object, asset or resource, wherein the system includes a computer failure detector to detect failure of any one of the computers and release means to release any lock acquired but not released by a failed computer, whereby the application program running conducted by the non-failed ones of the computers can continue allocation of the lock to a non-failed one of the computers in due course, if necessary.

Preferably, the system includes re-allocation means operable in the event of the detection of failure of one of the computers, and at that time of detection there being at least one other computer awaiting allocation of the lock, to re-allocate the lock to the, or one of, the computers awaiting allocation.

Preferably, the system includes identification means to identify any unreleased lock(s) held by a failed computer and to identify any computers awaiting allocation of the unreleased lock(s).

Preferably, the identification means comprises a table of locks allocated and a queue of computers awaiting lock allocation.

Preferably, the failure detection means interrogates each possible lock holding computer and absence of a reply to the interrogation is deemed to constitute computer failure.

Preferably, the detection means repeats the interrogation at predetermined intervals in response to a reply thereto indicating no failure of the interrogated computer.

Furthermore, there is also disclosed a single computer intended to operate in a multiple computer system which comprises a plurality of computers each having a local memory and each being interconnected via a communications network wherein different portions of at least one application program each written to execute on only a single computer, each execute substantially simultaneously on a corresponding one of the plurality of computers, and at least one memory location is replicated in the local memory of each the computer, the system further comprising updating means associated with each the computer to in due course update each the memory location via the communications network after each occasion at which each the memory location has its content written to, or re-written, with a new content,

the single computer comprising:

a local memory having at least one memory location intended to be updated via a communications port connectable to the communications network,

updating means to in due course update the memory locations of other substantially similar computers via the communications port; lock means associated with the local memory to acquire a lock on an object, asset or resource of the local memory, a computer failure detector to detect failure of another computer, and release means to release any lock acquired but not released by a failed computer, whereby the application program portion executing on the single computer can acquire the lock of failed computers in due course, if necessary.

Preferably, the system includes re-allocation means to re-allocate the acquired lock to another computer awaiting allocation.

Preferably, the system includes identification means to identify any unreleased lock(s) held by a failed computer and to identify any computers awaiting allocation of the unreleased lock(s).

Preferably, the identification means comprises a table of locks allocated and a queue of computers awaiting lock allocation.

Preferably, the failure detection means sends an interrogation to the communications port and absence of a reply to the interrogation is deemed to constitute computer failure.

Preferably, the detection means repeats the interrogation at predetermined intervals in response to a reply thereto.

In addition, there is also provided a computer program product comprising a set of program instructions stored in a storage medium and operable to permit a plurality of computers to carry out any of the above method(s).

Similarly, there is also provided a plurality of computers interconnected via a communications network and operable to ensure carrying out of any of the above method(s).

There is also provided an application program stored in a computer readable storage medium and modified to carry out any of the above method(s).

Furthermore, there is also provided in a single computer capable of interoperating with at least one other computer coupled to the single computer at least intermittently via a communications network to form a multiple computer system having a plurality of computers wherein each computer has a local memory, a method for handling a lock of an object, asset, or resource comprising:

executing at least a portion of at least one application program written to execute on only a single computer and modified to execute substantially simultaneously on one of the plurality of computers;

replicating at least one memory location in the local memory of each of the plurality of computers;

updating each the memory location of the other computer in due course via the communications network after each occasion at which a memory location has a memory content written to, or re-written, with a new content;

acquiring a lock on an object, asset or resource of the local memory;

detecting a failure of another computer, and

releasing any lock acquired but not released by a failed computer, so that the application program portion executing on the single computer can acquire the lock of failed computers in due course.

Preferably, the method comprises performing the modification of the at least a portion of the at least one application program written to execute on only a single computer to execute substantially simultaneously on one of the plurality of computers.

In addition, there is also provided a computer program recorded on a memory device comprising instructions which, when executed on a computer, perform in at least one single computer capable of interoperating with at least one other computer coupled to the single computer at least intermittently via a communications network to form a multiple computer system having a plurality of computers wherein each computer has a local memory, a method for handling a lock of an object, asset, or resource, the method comprising the steps of:

replicating at least one memory location in the local memory of each of the plurality of computers;

updating each the memory location of the other computer in due course via the communications network after each occasion at which a memory location has a memory content written to, or re-written, with a new content;

acquiring a lock on an object, asset or resource of the local memory;

detecting a failure of another computer, and

releasing any lock acquired but not released by a failed computer, so that the application program portion executing on the single computer can acquire the lock of failed computers in due course.

Preferably, the computer program further comprises instructions which, when executed on the computer, perform a method for handling a lock of an object, asset, or resource, the method further comprising the step of: performing the modification of the at least a portion of the at least one application program written to execute on only a single computer to execute substantially simultaneously on one of the plurality of computers.

### COPYRIGHT NOTICE

This patent specification and the Annexures which form a part thereof contains material which is subject to copyright protection. The copyright owner (which is the applicant) has no objection to the reproduction of this patent specification or related materials from publicly available associated Patent Office files for the purposes of review, but otherwise reserves all copyright whatsoever. In particular, the various instructions are not to be entered into a computer without the specific prior written approval of the copyright owner.

### ANNEXURE

LockClient.java

This excerpt is the source-code of LockClient, which executes on each node and requests lock acquisition and releases of the LockServer.

```
    import java.lang.*;
    import java.util.*;
    import java.net.*;
    import java.io.*;
    public class LockClient implements Runnable{
      /** Protocol specific values. */
      public final static int CLOSE = −1;
      public final static int NACK = 0;
      public final static int ACK = 1;
      public final static int ACQUIRE_LOCK = 10;
      public final static int RELEASE_LOCK = 20;
      /** LockServer network values. */
      public final static String serverAddress =
        System.getProperty(“LockServer_network_address”);
      public final static int serverPort =
        Integer.parseInt(System.-
        getProperty(“LockServer_network_port”));
      /** Table of global ID's for local objects.
          (hashcode-to-globalID mappings) */
      public final static Hashtable hashCodeToGlobalID = new
      Hashtable( );
      /** Private input/output objects used to
implement heartbeat operations. */
      public Socket pingSocket = null;
      public DataInputStream pingInputStream = null;
      public DataOutputStream pingOutputStream = null;
      /** Constructor. Initialise this instance with
all necessary resources for
          operation. */
      public LockClient(Socket s, DataInputStream in,
DataOutputStream out){
        pingSocket = s;
        pingInputStream = in;
        pingOutputStream = out;
      }
      /** Run method to execute the heartbeat operations. */
      public void run( ){
        while (!Thread.interrupted( )){
          try{
            long l = pingInputStream.readLong( );
            pingOutputStream.writeLong(l);
            pingOutputStream.flush( );
            if (l != −1){ // CLOSE
              pingOutputStream.close( );
              pingOutputStream = null;
              pingInputStream.close( );
              pingInputStream = null;
              pingSocket.close( );
              pingSocket = null;
              return;
            }
          }catch (IOException e){
            Thread.currentThread.interrupt( );
          }
        }
      }
      /** Called when an application is to acquire a lock. */
      public static void acquireLock(Object o){
        // First of all, we need to resolve the globalID for object ‘o’.
        // To do this we use the hashCodeToGlobalID table.
        int globalID = ((Integer)
        hashCodeToGlobalID.get(o)).intValue( );
        try{
          // Next, we want to connect to the LockServer,
which will grant us the
          // global lock.
          Socket socket = new Socket(serverAddress, serverPort);
          DataOutputStream out = new
DataOutputStream(socket.getOutputStream( ));
          DataInputStream in = new
DataInputStream(socket.getInputStream( ));
          // Ok, now send the serialized request to the lock server.
          out.writeInt(ACQUIRE_LOCK);
          out.writeInt(globalID);
          out.flush( );
          // Now wait for the reply.
```

| | |
|---|---|
| int status = in.readInt( ); | // This is a blocking call. |
| So we will | |
| | // wait until the remote side |
| sends | |
| | // something. |

```
          if (status == NACK){
            throw new AssertionError(“Negative acknowledgement. “
              + “Request failed.”);
          }else if (status != ACK){
            throw new AssertionError(“Unknown acknowledgement: ”
              + status + “. Request failed.”);
          }
          // Start heartbeat thread for this acquired lock.
          new Thread(new LockClient(socket, in, out)).start( );
          // This is a good acknowledgement, thus we can return now
because
          // global lock is now acquired.
          return;
        }catch (IOException e){
          throw new AssertionError(“Exception: ” + e.toString( ));
        }
      }
      /** Called when an application is to release a lock. */
      public static void releaseLock(Object o){
      // First of all, we need to resolve the globalID for object ‘o’.
      // To do this we use the hashCodeToGlobalID table.
      int globalID = ((Integer) hashCodeToGlobalID.get(o)).intValue( );
      try{
        // Next, we want to connect to the LockServer, which records
us as the
        // owner of the global lock for object ‘o’.
        Socket socket = new Socket(serverAddress, serverPort);
        DataOutputStream out = new
DataOutputStream(socket.getOutputStream( ));
        DataInputStream in = new
DataInputStream(socket.getInputStream( ));
        // Ok, now send the serialized request to the lock server.
        out.writeInt(RELEASE_LOCK);
        out.writeInt(globalID);
        out.flush( );
        // Now wait for the reply.
```

| | |
|---|---|
| int status = in.readInt( ); | // This is a blocking call. |
| So we will | |
| | // wait until the remote side |
| sends | |
| | // something. |

```
        if (status == NACK){
          throw new AssertionError(“Negative acknowledgement. “
            + “Request failed.”);
        }else if (status != ACK){
          throw new AssertionError(“Unknown acknowledgement: ”
            + status + “. Request failed.”);
        }
        // Close down the connection.
        out.writeInt(CLOSE);
        out.flush( );
        out.close( );
        in.close( );
        socket.close( ); // Make sure to close the socket.
        // This is a good acknowledgement, return because global lock
is now
        // released.
        return;
      }catch (IOException e){
        throw new AssertionError(“Exception: ” + e.toString( ));
      }
    }
  }
```

LockServer.java

This excerpt is the source-code of LockServer, which executes the lock acquisition and release processes for each node, with handling for failed nodes.

```
    import java.lang.*;
    import java.util.*;
    import java.net.*;
    import java.io.*;
    public class LockServer implements Runnable{
      /** Protocol specific values */
      public final static int CLOSE = −1;
      public final static int NACK = 0;
      public final static int ACK = 1;
      public final static int ACQUIRE_LOCK = 10;
      public final static int RELEASE_LOCK = 20;
      /** LockServer network values. */
      public final static int serverPort = 20001;
      /** Table of lock records. */
      public final static Hashtable locks = new Hashtable( );
      /** Linked list of waiting LockManager objects. */
      public LockServer next = null;
      /** Address of remote LockClient. */
      public final String address;
      /** Private input/output objects. */
      private Socket socket = null;
      private DataOutputStream outputStream;
      private DataInputStream inputStream;
      /** Private instance field signaling the lock is acquired and
heartbeat
          should be engaged. */
      private boolean acquired = false;
      public static void main(String[ ] s)
      throws Exception{
        System.out.println(“LockServer_network_address=”
          + InetAddress.getLocalHost( ).getHostAddress( ));
        System.out.println(“LockServer_network_port=” + serverPort);
        // Create a serversocket to accept incoming lock operation
connections.
        ServerSocket serverSocket = new ServerSocket(serverPort);
        while (!Thread.interrupted( )){
          // Block until an incoming lock operation connection.
          Socket socket = serverSocket.accept( );
          // Create a new instance of LockServer to manage this lock
operation
          // connection.
          new Thread(new LockServer(socket)).start( );
        }
      }
      /** Constructor. Initialise this new LockServer instance with
necessary
          resources for operation. */
      public LockServer(Socket s){
        socket = s;
        try{
          outputStream = new DataOutputStream(s.getOutputStream( ));
          inputStream = new DataInputStream(s.getInputStream( ));
          address = s.getInetAddress( ).getHostAddress( );
        }catch (IOException e){
          throw new AssertionError(“Exception: ” + e.toString( ));
        }
      }
      /** Main code body. Decode incoming lock operation requests and
execute
          accordingly. */
      public void run( ){
        try{
          // All commands are implemented as 32bit integers.
          // Legal commands are listed in the “protocol specific
values” fields
          // above.
          int command = inputStream.readInt( );
```

| | |
|---|---|
| if (command == ACQUIRE_LOCK){ | // This is an |
| ACQUIRE_LOCK | |
| | //operation. |

```
            // Read in the globalID of the object to be locked.
            int globalID = inputStream.readInt( );
            // Synchronize on the locks table in order to ensure
thread-safety.
            synchronized (this){
              synchronized (locks){
                // Check for an existing owner of this lock.
                LockServer lock = (LockServer) locks.get(
                  new Integer(globalID));
```

| | |
|---|---|
| if (lock == null){ | // No-one presently owns this |
| lock, so | |
| | // acquire it. |

locks.put(new Integer(globalID), this);

| | |
|---|---|
| acquireLock( ); | // Signal to the client the |
| successful | |
| | // acquisition of this lock. |
| }else{ | // Already owned. Append |
| ourselves to | |
| | // end of queue. |

```
                  // Search for the end of the queue. (Implemented
as
                  // linked-list)
                  while (lock.next != null){
                    lock = lock.next;
                  }
```

| | |
|---|---|
| lock.next = this; | // Append this lock request at |

```
end.
                }
              }
              // Implement Heartbeat code here.
              while (!acquired)
                this.wait( );
              // Set the socket timeout property.
              socket.setSoTimeout(10000); // 10 seconds.
              try{
                while (!Thread.interrupted( ) && acquired){
                  long ping = System.currentTimeMillis( );
                  outputStream.writeLong(1);
                  long pong = inputStream.readLong( );
                  if (ping != pong){
                    throw new AssertionError(“protocol error”);
                  }
                }
              }catch (IOException e){
                synchronized (locks){
                  LockServer ls = (LockServer) locks.get(
                    new Integer(globalID));
                  if (ls == null){
                    throw new AssertionError(“Unlocked. Release
Failed.”);
                  }else if (ls != this){
                    throw new AssertionError(“Trying to release a
lock”
                      + “ which this client doesn't”);
                  }
                  ls = ls.next;
                  ls.acquireLock( );
                  locks.put(new Integer(globalID), ls);
                  next = null;
                }
              }
            }
          }else if (command == RELEASE_LOCK){ // This is a
RELEASE_LOCK
```

//operation.

```
            // Read in the globalID of the object to be locked.
            int globalID = inputStream.readInt( );
            // Synchronize on the locks table in order to ensure
thread-safety.
            synchronized (locks){
              // Check to make sure we are the owner of this lock.
              LockServer lock = (LockServer) locks.get(new
Integer(globalID));
              if (lock == null){
                throw  new  AssertionError(“Unlocked.  Release
failed.”);
              }else if (lock.address != this.address){
                throw new AssertionError(“Trying to release a lock
which “
                    + “this client doesn't own. Release failed.”);
              }
              // Notify the heartbeat thread to cease operations.
```

| | |
|---|---|
| lock.acquired = false; | this should stop the |
| pingpong loop | |
| | // operating and kill thread. |
| lock = lock.next; | |
| lock.acquireLock( ); | // Signal to the client the |
| successful | |
| // acquisition of this lock. | |

```
              // Shift the linked list of pending acquisitions
forward by one.
              locks.put(new Integer(globalID), lock);
              // Clear stale reference.
              next = null;
            }
```

| | |
|---|---|
| releaseLock( ); | // Signal to the client the successful |
| release of | |
| | // this lock. |
| }else{ | // Unknown command. |

```
            throw new AssertionError(“Unknown command. Operation
failed.”);
          }
        }catch (Exception e){
          throw new AssertionError(“Exception: ” + e.toString( ));
        }finally{
          try{
            // Closing down. Cleanup this connection.
            outputStream.flush( );
            outputStream.close( );
            inputStream.close( );
            socket.close( );
          }catch (Throwable t){
            t.printStackTrace( );
          }
          // Garbage these references.
          outputStream = null;
          inputStream = null;
          socket = null;
        }
      }
      /** Send a positive acknowledgement of an ACQUIRE_LOCK operation.
*/
      public void acquireLock( ) throws IOException{
        synchronized (this){
          outputStream.writeInt(ACK);
          outputStream.flush( );
          // Activate heartbeat operations on this socket.
          acquired = true;
          this.notify( );
        }
      }
      /** Send a positive acknowledgement of a RELEASE_LOCK operation. */
      public void releaseLock( ) throws IOException{
        outputStream.writeInt(ACK);
        outputStream.flush( );
      }
    }
```

1. In a multiple computer system comprising a plurality of computers each including a local processor and a local memory coupled with the local processor including a first computer and a second computer interconnected via a communications link or network operating in a replicated shared memory arrangement, a method comprising:
acquiring (allocating) and releasing (de-allocating) replicated mutual-exclusion permission(s) in sequence by or between a plurality of computers of said multiple computer system; and
following a failure of any particular one of the plurality of computers which has acquired but not released any particular mutual-exclusion permission(s):
a. releasing or revoking or causing to be released or revoked said particular mutual-exclusion permission(s) so that an application program executing on non-failed ones of said plurality of computers can continue execution in an uninterrupted manner by acquiring (allocating) and releasing (deallocating) said particular mutual-exclusion permission(s) of said failed computer.

2. A method as in claim 1, wherein said mutual-exclusion permission(s) comprise synchronization (or synchronizing) lock operations.

3. A method as in claim 1, wherein at the time of said computer failure at least one other of the plurality of computers is awaiting allocation of said particular mutual-exclusion permission(s), and further including the step of:
b. allocating said specific mutual-exclusion permission(s) to the, or one of, said at least one other of the plurality of computers awaiting allocation of said particular mutual-exclusion permission(s).

4. A method as in claim 2, wherein at the time of said computer failure at least one other of the plurality of computers is awaiting allocation of said particular mutual-exclusion permission(s), and further including the step of:
b. allocating said specific mutual-exclusion permission(s) to the, or one of, said at least one other of the plurality of computers awaiting allocation of said particular mutual-exclusion permission(s).

5. A method as in claim 3, further including:
c. detecting said computer failure;
d. determining whether the failed computer held any unreleased mutual-exclusion permissions prior to said computer failure;
e. determining the identity of said other computer(s) awaiting acquisition of the same mutual-exclusion permission(s); and
f. allocating said particular mutual-exclusion permission(s) to the other computer(s) awaiting acquisition of the same mutual-exclusion permission(s) identified in step (e).

6. A method as in claim 5, further including the steps of:
g. maintaining a table of allocated mutual-exclusion permission(s) which table includes the identity of the computer to which each mutual-exclusion permission has been allocated (or acquired);
h. carrying out step (e) by consulting said table of allocated mutual-exclusion permission(s); and
i. updating said table of allocated mutual-exclusion permission(s) after carrying out the allocation of said particular mutual-exclusion permission(s) to the other computers as in step (f).

7. A method as in claim 6, further including the steps of:
j. requiring any mutual-exclusion permission(s) requesting computer to interrogate each possible mutual-exclusion permission holding computer as to whether it holds the particular mutual-exclusion permission; and
k. utilizing the absence of a positive answer to the interrogation in step (j) to trigger allocation of said particular mutual-exclusion permission to said requesting computer so that any mutual-exclusion permission holding computer which fails to communicate a positive answer is determined to be incapable of communicating said positive answer and as a result permitting allocation of said particular mutual-exclusion permission to said mutual-exclusion permission requesting computer.

8. A method as in claim 7, wherein the period of said absence of a positive answer is limited to a predetermined duration of time.

9. A method as in claim 7, wherein the period of said absence of a positive answer is limited to a dynamically determined duration of time.

10. A method as in claim 1, further including the steps of:
identifying any unreleased mutual-exclusion permission(s) held by a failed computer; and
identifying any computers awaiting allocation of said unreleased mutual-exclusion permission(s).

11. A method as in claim 10, wherein:
said identifying any unreleased mutual-exclusion permissions(s) comprises querying a table of mutual-exclusion permissions allocated;
said identifying any computers awaiting allocation comprises querying a queue of computers awaiting mutual-exclusion allocation; and
said interrogation is repeated at predetermined time intervals in response to a reply thereto indicating no failure of the interrogated computer to verify the continued non-failed status of each computer.

12. A method as in claim 1, further including interrogating each possible mutual-exclusion permission holding computer from among the plurality of computers and absence of receiving a reply to said interrogation from any particular computer then detecting the non-replying computer as a failed computer.

13. A method as in claim 1, wherein said local memory(ies) of each said computer are independent of said local memory(ies) of each other computer; and said local processors may only access said local memory(ies) of the same computer in which the local processor is located.

14. A method as in claim 1, wherein at least a first application program written to operate on a single one of said computers, is operating substantially simultaneously on different ones of said multiple computers.

15. A method as in claim 14, wherein said application program operating substantially simultaneously on each of said different ones of said computers, may only access said local memory(ies) of the same computer.

16. A method as in claim 15, wherein said access is satisfied by said local memory(ies) of the same computer independently of (or without the aid of) said local memory(ies) of any other computer.

17. A method as in claim 15, wherein said access includes reading and/or writing content or values stored or resident within said local memory(ies) of the same computer.

18. A method as in claim 16, wherein said access includes reading and/or writing content or values stored or resident within said local memory(ies) of the same computer.

19. A method as in claim 15, wherein said access is restricted to reading and/or writing content or values stored or resident within said local memory(ies) of the same computer.

20. A method as in claim 16, wherein said access is restricted to reading and/or writing content or values stored or resident within said local memory(ies) of the same computer.

21. A method as in claim 15, wherein said access includes reading and/or writing content or values of real or virtual memory addresses of or resident within said local memory(ies) of the same computer.

22. A method as in claim 16, wherein said access includes reading and/or writing content or values of real or virtual memory addresses of or resident within said local memory(ies) of the same computer.

23. A method as in claim 17, wherein said access includes reading and/or writing content or values of real or virtual memory addresses of or resident within said local memory(ies) of the same computer.

24. A method as in claim 15, wherein said access is restricted to reading and/or writing content or values of real or virtual memory addresses of or resident within said local memory(ies) of the same computer.

25. A method as in claim 16, wherein said access is restricted to reading and/or writing content or values of real or virtual memory addresses of or resident within said local memory(ies) of the same computer.

26. A method as in claim 17, wherein said access is restricted to reading and/or writing content or values of real or virtual memory addresses of or resident within said local memory(ies) of the same computer.

27. A method as in claim 15, wherein at least one memory location and/or memory value of said application program is substantially similarly replicated in said local memory(ies) of said different ones of said multiple computers.

28. A method as in claim 24, wherein said substantially similarly replicated memory location(s) and/or value(s) are stored non-identically in said local memory(ies) of said different ones of said multiple computers.

29. A method as in claim 25, wherein said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s).

30. A method as in claim 29, wherein said in-due-course updating provides that said replicated memory locations are updated to remain substantially similar upon occasion of any one of said computers simultaneously operating said application program causing modification of the contents of said replicated memory location.

31. A method as in claim 1, wherein:
said local memory(ies) of each said computer are independent of said local memory(ies) of each other computer;
said local processors may only access said local memory(ies) of the same computer in which the local processor is located;
at least a first application program written to operate on a single one of said computers, is operating substantially simultaneously on different ones of said multiple computers;
said application program operating substantially simultaneously on each of said different ones of said computers, may only access said local memory(ies) of the same computer;
said access is satisfied by said local memory(ies) of the same computer independently of (or without the aid of) said local memory(ies) of any other computer;
said access includes reading and/or writing content or values stored or resident within said local memory(ies) of the same computer, or said access is restricted to reading and/or writing content or values stored or resident within said local memory(ies) of the same computer;
said access includes reading and/or writing content or values of real or virtual memory addresses of or resident within said local memory(ies) of the same computer, or said access is restricted to reading and/or writing content or values of real or virtual memory addresses of or resident within said local memory(ies) of the same computer;
at least one memory location and/or memory value of said application program is substantially similarly replicated in said local memory(ies) of said different ones of said multiple computers;
said substantially similarly replicated memory location(s) and/or value(s) are stored non-identically in said local memory(ies) of said different ones of said multiple computers;
said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s); and
said in-due-course updating provides that said replicated memory locations are updated to remain substantially similar upon occasion of any one of said computers simultaneously operating said application program causing modification of the contents of said replicated memory location.

32. A method as in claim 11, wherein:
said local memory(ies) of each said computer are independent of said local memory(ies) of each other computer;
said local processors may only access said local memory(ies) of the same computer in which the local processor is located;
at least a first application program written to operate on a single one of said computers, is operating substantially simultaneously on different ones of said multiple computers;
said application program operating substantially simultaneously on each of said different ones of said computers, may only access said local memory(ies) of the same computer;
said access is satisfied by said local memory(ies) of the same computer independently of (or without the aid of) said local memory(ies) of any other computer;
said access includes reading and/or writing content or values stored or resident within said local memory(ies) of the same computer, or said access is restricted to reading and/or writing content or values stored or resident within said local memory(ies) of the same computer;
said access includes reading and/or writing content or values of real or virtual memory addresses of or resident within said local memory(ies) of the same computer, or said access is restricted to reading and/or writing content or values of real or virtual memory addresses of or resident within said local memory(ies) of the same computer;
at least one memory location and/or memory value of said application program is substantially similarly replicated in said local memory(ies) of said different ones of said multiple computers;
said substantially similarly replicated memory location(s) and/or value(s) are stored non-identically in said local memory(ies) of said different ones of said multiple computers;
said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s); and
said in-due-course updating provides that said replicated memory locations are updated to remain substantially similar upon occasion of any one of said computers simultaneously operating said application program causing modification of the contents of said replicated memory location.

33. A computer program stored on a computer readable memory device comprising instructions which, when executed on a computer, perform in at least one single computer capable of interoperating with at least one other computer coupled to at least one said single computer at least intermittently via a communications network to form a multiple computer system having a plurality of computers wherein each computer has a local memory and the multiple computer system operating in a replicated shared memory arrangement, a method comprising the steps of:
acquiring (allocating) and releasing (de-allocating) replicated mutual-exclusion permission(s) in sequence by or between a plurality of computers of said multiple computer system; and
following a failure of any particular one of the plurality of computers which has acquired but not released any particular mutual-exclusion permission(s):
a. releasing or revoking or causing to be released or revoked said particular mutual-exclusion permission(s) so that an application program executing on non-failed ones of said plurality of computers can continue execution in an uninterrupted manner by acquiring (allocating) and releasing (deallocating) said particular mutual-exclusion permission(s) of said failed computer.

34. A computer program product as in claim 33, wherein said mutual-exclusion permission(s) comprise synchronization (or synchronizing) lock operations.

35. A computer program product as in claim 1, wherein at the time of said computer failure at least one other of the plurality of computers is awaiting allocation of said particular mutual-exclusion permission(s), and further including the step of:
b. allocating said specific mutual-exclusion permission(s) to the, or one of, said at least one other of the plurality of computers awaiting allocation of said particular mutual-exclusion permission(s).

36. A computer program product as in claim 2, wherein at the time of said computer failure at least one other of the plurality of computers is awaiting allocation of said particular mutual-exclusion permission(s), and further including the step of:
b. allocating said specific mutual-exclusion permission(s) to the, or one of, said at least one other of the plurality of computers awaiting allocation of said particular mutual-exclusion permission(s).

37. A computer program product as in claim 3, further including:
c. detecting said computer failure;
d. determining whether the failed computer held any unreleased mutual-exclusion permissions prior to said computer failure;
e. determining the identity of said other computer(s) awaiting acquisition of the same mutual-exclusion permission(s); and
f. allocating said particular mutual-exclusion permission(s) to the other computer(s) awaiting acquisition of the same mutual-exclusion permission(s) identified in step (e).

38. A computer program product as in claim 5, further including the steps of:
g. maintaining a table of allocated mutual-exclusion permission(s) which table includes the identity of the computer to which each mutual-exclusion permission has been allocated (or acquired);
h. carrying out step (e) by consulting said table of allocated mutual-exclusion permission(s); and
i. updating said table of allocated mutual-exclusion permission(s) after carrying out the allocation of said particular mutual-exclusion permission(s) to the other computers as in step (f).

39. A computer program product as in claim 6, further including the steps of:
j. requiring any mutual-exclusion permission(s) requesting computer to interrogate each possible mutual-exclusion permission holding computer as to whether it holds the particular mutual-exclusion permission; and
k. utilizing the absence of a positive answer to the interrogation in step (j) to trigger allocation of said particular mutual-exclusion permission to said requesting computer so that any mutual-exclusion permission holding computer which fails to communicate a positive answer is determined to be incapable of communicating said positive answer and as a result permitting allocation of said particular mutual-exclusion permission to said mutual-exclusion permission requesting computer.

40. A computer program product as in claim 7, wherein the period of said absence of a positive answer is limited to a predetermined duration of time.

41. A computer program product as in claim 7, wherein the period of said absence of a positive answer is limited to a dynamically determined duration of time.

42. A computer program product as in claims 33-41, further including the steps of:
identifying any unreleased mutual-exclusion permission(s) held by a failed computer; and
identifying any computers awaiting allocation of said unreleased mutual-exclusion permission(s).

43. A computer program product as in claim 42, wherein:
said identifying any unreleased mutual-exclusion permissions(s) comprises querying a table of mutual-exclusion permissions allocated; and
said identifying any computers awaiting allocation comprises querying a queue of computers awaiting mutual-exclusion allocation.

44. A computer program product as in claims 33-43, further including interrogating each possible mutual-exclusion permission holding computer from among the plurality of computers and absence of receiving a reply to said interrogation from any particular computer then detecting the non-replying computer as a failed computer.

45. A computer program product as in claim 44, wherein said interrogation is repeated at predetermined time intervals in response to a reply thereto indicating no failure of the interrogated computer to verify the continued non-failed status of each computer.

46. A multiple computer system comprising:
a plurality of computers each including a local processor and a local memory coupled with the local processor including a first computer and a second computer interconnected via a communications link or network operating in a replicated shared memory arrangement;
means for acquiring (allocating) and releasing (de-allocating) replicated mutual-exclusion permission(s) in sequence by or between a plurality of computers of said multiple computer system; and
means for releasing or revoking or causing to be released or revoked said particular mutual-exclusion permission(s) following a failure of any particular one of the plurality of computers which has acquired but not released any particular mutual-exclusion permission(s) so that an application program executing on non-failed ones of said plurality of computers can continue execution in an uninterrupted manner by acquiring (allocating) and releasing (deallocating) said particular mutual-exclusion permission(s) of said failed computer.

47. A multiple computer system as in claim 46, wherein said mutual-exclusion permission(s) comprise synchronization (or synchronizing) lock operations.

48. A multiple computer system as in claim 46, wherein at the time of said computer failure at least one other of the plurality of computers is awaiting allocation of said particular mutual-exclusion permission(s), and further including:
b. means for allocating said specific mutual-exclusion permission(s) to the, or one of, said at least one other of the plurality of computers awaiting allocation of said particular mutual-exclusion permission(s).

49. A multiple computer system as in claim 47, wherein at the time of said computer failure at least one other of the plurality of computers is awaiting allocation of said particular mutual-exclusion permission(s), and further including:
b. means for allocating said specific mutual-exclusion permission(s) to the, or one of, said at least one other of the plurality of computers awaiting allocation of said particular mutual-exclusion permission(s).

50. A multiple computer system as in claim 48, further including:
c. means for detecting said computer failure;
d. means for determining whether the failed computer held any unreleased mutual-exclusion permissions prior to said computer failure;
e. means for determining the identity of said other computer(s) awaiting acquisition of the same mutual-exclusion permission(s); and
f. means for allocating said particular mutual-exclusion permission(s) to the other computer(s) awaiting acquisition of the same mutual-exclusion permission(s) identified in step (e).

51. A multiple computer system as in claim 5, further including:
g. means for maintaining a table of allocated mutual-exclusion permission(s) which table includes the identity of the computer to which each mutual-exclusion permission has been allocated (or acquired);
h. means for carrying out step (e) by consulting said table of allocated mutual-exclusion permission(s); and
i. means for updating said table of allocated mutual-exclusion permission(s) after carrying out the allocation of said particular mutual-exclusion permission(s) to the other computers as in step (f).

52. A multiple computer system as in claim 51, further including:
j. means for requiring any mutual-exclusion permission(s) requesting computer to interrogate each possible mutual-exclusion permission holding computer as to whether it holds the particular mutual-exclusion permission; and
k. means for utilizing the absence of a positive answer to the interrogation in step (j) to trigger allocation of said particular mutual-exclusion permission to said requesting computer so that any mutual-exclusion permission holding computer which fails to communicate a positive answer is determined to be incapable of communicating said positive answer and as a result permitting allocation of said particular mutual-exclusion permission to said mutual-exclusion permission requesting computer.

53. A multiple computer system as in claim 52, wherein the period of said absence of a positive answer is limited to a predetermined duration of time.

54. A multiple computer system as in claim 52, wherein the period of said absence of a positive answer is limited to a dynamically determined duration of time.

55. A multiple computer system as in claim 54, further including:
means for identifying any unreleased mutual-exclusion permission(s) held by a failed computer; and
means for identifying any computers awaiting allocation of said unreleased mutual-exclusion permission(s).

56. A multiple computer system as in claim 55, wherein:
said identifying any unreleased mutual-exclusion permissions(s) comprises querying a table of mutual-exclusion permissions allocated; and
said identifying any computers awaiting allocation comprises querying a queue of computers awaiting mutual-exclusion allocation.

57. A multiple computer system as in claim 56, further including means for interrogating each possible mutual-exclusion permission holding computer from among the plurality of computers and absence of receiving a reply to said interrogation from any particular computer then detecting the non-replying computer as a failed computer.

58. A multiple computer system as in claim 55, wherein said interrogation is repeated at predetermined time intervals in response to a reply thereto indicating no failure of the interrogated computer to verify the continued non-failed status of each computer.

59. A multiple computer system as in claim 46, wherein said local memory(ies) of each said computer are independent of said local memory(ies) of each other computer.

60. A multiple computer system as in claim 46, wherein said local processors may only access said local memory(ies) of the same computer in which the local processor is located.

61. A multiple computer system as in claim 46, wherein at least a first application program written to operate on a single one of said computers, is operating substantially simultaneously on different ones of said multiple computers.

62. A multiple computer system as in claim 61, wherein said application program operating substantially simultaneously on each of said different ones of said computers, may only access said local memory(ies) of the same computer.

63. A multiple computer system as in claim 62, wherein said access is satisfied by said local memory(ies) of the same computer independently of (or without the aid of) said local memory(ies) of any other computer.

64. A multiple computer system as in claim 62, wherein said access includes reading and/or writing content or values stored or resident within said local memory(ies) of the same computer.

65. A multiple computer system as in claim 63, wherein said access includes reading and/or writing content or values stored or resident within said local memory(ies) of the same computer.

66. A multiple computer system as in claim 62, wherein said access is restricted to reading and/or writing content or values stored or resident within said local memory(ies) of the same computer.

67. A multiple computer system as in claim 63, wherein said access is restricted to reading and/or writing content or values stored or resident within said local memory(ies) of the same computer.

68. A multiple computer system as in claim 62, wherein said access includes reading and/or writing content or values of real or virtual memory addresses of or resident within said local memory(ies) of the same computer.

69. A multiple computer system as in claim 63, wherein said access includes reading and/or writing content or values of real or virtual memory addresses of or resident within said local memory(ies) of the same computer.

70. A multiple computer system as in claim 64, wherein said access includes reading and/or writing content or values of real or virtual memory addresses of or resident within said local memory(ies) of the same computer.

71. A multiple computer system as in claim 62, wherein said access is restricted to reading and/or writing content or values of real or virtual memory addresses of or resident within said local memory(ies) of the same computer.

72. A multiple computer system as in claim 63, wherein said access is restricted to reading and/or writing content or values of real or virtual memory addresses of or resident within said local memory(ies) of the same computer.

73. A multiple computer system as in claim 64, wherein said access is restricted to reading and/or writing content or values of real or virtual memory addresses of or resident within said local memory(ies) of the same computer.

74. A multiple computer system as in claim 62, wherein at least one memory location and/or memory value of said application program is substantially similarly replicated in said local memory(ies) of said different ones of said multiple computers.

75. A multiple computer system as in claim 71, wherein said substantially similarly replicated memory location(s) and/or value(s) are stored non-identically in said local memory(ies) of said different ones of said multiple computers.

76. A multiple computer system as in claim 72, wherein said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s).

77. A multiple computer system as in claim 76, wherein said in-due-course updating provides that said replicated memory locations are updated to remain substantially similar upon occasion of any one of said computers simultaneously operating said application program causing modification of the contents of said replicated memory location.

78. A multiple computer system as in claim 46, wherein:
said local memory(ies) of each said computer are independent of said local memory(ies) of each other computer;
said local processors may only access said local memory(ies) of the same computer in which the local processor is located;
at least a first application program written to operate on a single one of said computers, is operating substantially simultaneously on different ones of said multiple computers;
said application program operating substantially simultaneously on each of said different ones of said computers, may only access said local memory(ies) of the same computer;
said access is satisfied by said local memory(ies) of the same computer independently of (or without the aid of) said local memory(ies) of any other computer;
said access includes reading and/or writing content or values stored or resident within said local memory(ies) of the same computer, or said access is restricted to reading and/or writing content or values stored or resident within said local memory(ies) of the same computer;
said access includes reading and/or writing content or values of real or virtual memory addresses of or resident within said local memory(ies) of the same computer, or said access is restricted to reading and/or writing content or values of real or virtual memory addresses of or resident within said local memory(ies) of the same computer;
at least one memory location and/or memory value of said application program is substantially similarly replicated in said local memory(ies) of said different ones of said multiple computers;
said substantially similarly replicated memory location(s) and/or value(s) are stored non-identically in said local memory(ies) of said different ones of said multiple computers;
said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s); and
said in-due-course updating provides that said replicated memory locations are updated to remain substantially similar upon occasion of any one of said computers simultaneously operating said application program causing modification of the contents of said replicated memory location.

79. A multiple computer system as in claim 56, wherein:
said local memory(ies) of each said computer are independent of said local memory(ies) of each other computer;
said local processors may only access said local memory(ies) of the same computer in which the local processor is located;
at least a first application program written to operate on a single one of said computers, is operating substantially simultaneously on different ones of said multiple computers;
said application program operating substantially simultaneously on each of said different ones of said computers, may only access said local memory(ies) of the same computer;
said access is satisfied by said local memory(ies) of the same computer independently of (or without the aid of) said local memory(ies) of any other computer;
said access includes reading and/or writing content or values stored or resident within said local memory(ies) of the same computer, or said access is restricted to reading and/or writing content or values stored or resident within said local memory(ies) of the same computer;
said access includes reading and/or writing content or values of real or virtual memory addresses of or resident within said local memory(ies) of the same computer, or said access is restricted to reading and/or writing content or values of real or virtual memory addresses of or resident within said local memory(ies) of the same computer;
at least one memory location and/or memory value of said application program is substantially similarly replicated in said local memory(ies) of said different ones of said multiple computers;
said substantially similarly replicated memory location(s) and/or value(s) are stored non-identically in said local memory(ies) of said different ones of said multiple computers;
said substantially similarly replicated memory location(s) and/or memory value(s) are updated through in-due-course updating to remain substantially similar upon occasion of any one of said plurality of computers simultaneously operating said application program modifying, or causing to be modified, the value(s) or content(s) of said substantially similarly replicated memory location(s) and/or memory value(s); and
said in-due-course updating provides that said replicated memory locations are updated to remain substantially similar upon occasion of any one of said computers simultaneously operating said application program causing modification of the contents of said replicated memory location.
